(19) United States
(12) Patent Application Publication
(10) Pub. No.: US 2005/0259390 A1
(43) Pub. Date: Nov. 24, 2005

(54) Latch hook structure of removable storage devices

(75) Inventors: Chia-Kang Wu, Taipei City (TW); Zheng-Jin Zhao, Taipei City (TW); Fu-Jung Hsui, Taipei City (TW)

Correspondence Address: BACON & THOMAS, PLLC, 625 SLATERS LANE, FOURTH FLOOR, ALEXANDRIA, VA, 22314, US

(73) Assignee: Tatung Co., Ltd., Taipei City (TW)

(21) Appl. No.: 11/091,598

(22) Filed: Mar. 29, 2005

(30) Foreign Application Priority Data
May 18, 2004 (TW) 093207776

(51) Int. Cl. G06F 1/16

(52) U.S. Cl. 361/684

(57) ABSTRACT

The present invention relates to a latch hook structure for removable storage devices, comprising a removable storage device which has an ornamental front face and two sides where two tracks parallel to each other are mounted respectively, wherein at least one of the two tracks has a first sliding structure at the front end thereof; and a latch hook member correspondingly assembled to the front end of track, wherein latch hook member includes a straight plate having a front edge integrally formed with a latch hook part around which latch hook space is reserved and a second sliding structure corresponding to the first sliding structure to effect a relative slide backwards and forwards, and is further connected to the track with a restoring spring for providing latch hook member with a backward restoring elastic force to keep latch hook part aligned with ornamental front face of the removable storage device.

### BACKGROUND OF THE INVENTION

1. Field of the Invention

The present invention relates to a latch hook structure, and more particularly to a latch hook structure suited to removable storage devices in a computer system, especially in a computer server.

2. Description of Related Art

The computer server is widely used in various enterprises, characterized by the case having standardized dimensions so as to maintain the server mounted in a central control room at a maximum space usage rate.

In general, data storage capacity of the servers having the same specification is increased if hard disk drive (HDD) connected is increased in number within a unit space to increase competitiveness in confronting the information explosive era, in addition to the increase of the capacity of the HDD. However, the computer servers, just like the common personal computers, require a CD-ROM drive or a floppy disk drive (FDD) to function such as software installation and version update. Because they are not used frequently, it is not economic for such work that is important but seldom utilized to occupy a space as the same as the HDD in every computer server.

It will therefore be more economic to use a removable CR-ROM/FDD for the special occasions if necessary, and normally, the HDD is sufficient for the rest. Due to limitation to the size of the front panel of the removable CD-ROM/FDD, no structure of both ornament and convenient use is provided to facilitate the user's detachment.

Therefore, it is desirable to provide an improved latch hook structure for removable storage devices to mitigate and/or obviate the aforementioned problems.

### SUMMARY OF THE INVENTION

The present invention has been accomplished under the circumstances in view. It is therefore the main object of the present invention to provide a latch hook structure for removable storage devices so that the removable storage devices not only have a neat and ornamental appearance but also are easily attached or detached by latch hook.

To attain the aforesaid objective, a latch hook structure of removable storage devices according to the present invention comprises a removable storage device having an ornamental front face and two sides on which two tracks parallel to each other are mounted respectively, wherein at least one of the two tracks has a fist sliding structure at the front end thereof; and at least a latch hook member correspondingly assembled to the front end of the at least one track, wherein the hooking member includes a straight plate and a second sliding structure. The aforesaid straight plate having a front edge integrally formed with a latch hook part around which a latch hook space is reserved and the aforesaid second sliding structure corresponding to the fist sliding structure of said at least one track to effect a relative slide backwards and forwards, and is further connected to the said at least one track with a restoring spring for providing said at least one latch hook member with a backward restoring elastic force to keep the latch hook part aligned with the ornamental front face of the removable storage device for a long term.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view of an embodiment of the present invention.

FIG. 2 is an explosive view of part of an embodiment of the present invention.

FIG. 3 is a schematic view of part of an embodiment of the present invention.

### DETAILED DESCRIPTION OF THE PREFERRED EMBODIMENT

A preferred embodiment of the invention will be described with reference to the accompanying drawings for illustrating the present invention.

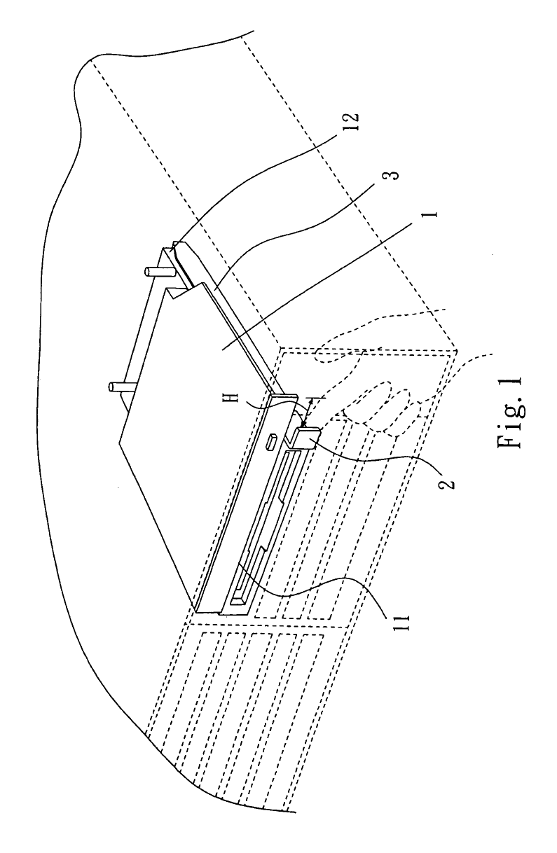

Referring to FIG. 1, a latch hook structure 2 is showing for removable storage devices according to the present invention adapted to a removable CD-ROM/HDD combo 1 and assembled to a computer. In this embodiment, the CD-ROM/HDD combo is used for illustration. The latch hook structure 2 for removable storage devices according to the present invention is not limited to the CD-ROM/HDD combo, and applicable to another removable storage device such as a removable HDD, a removable FDD or the like.

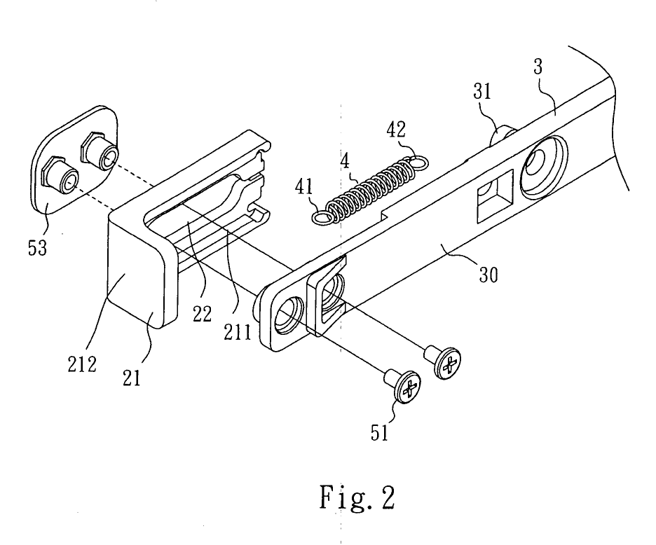

Referring to FIG. 1 and FIG. 2, an exploder view of part of a latch hook structure for removable storage devices according to the present invention is shown.

In these figures, an embodiment of the present invention comprises a removable storage device 1 and a latch hook member 21. The removable storage device 1 includes an ornamental front face 11 and two sides 12 on which two tracks 3 parallel to each other are mounted. The left track 3 has a front end 31 where two screws 51 are disposed in parallel and pass through threaded holes 32 and a sliding slot 22 to be locked to a pad 53. In this embodiment, the pad 53 is an iron plate having hexagonal bolts riveted thereon. The latch hook member 21 is correspondingly assembled to the front end 30 of the left track 3, including a straight plate 211 and the sliding slot 22. The sliding slot 22 corresponds to the screws 51 of the said at least one track to cause a relative slide backwards and forwards. It is noted that although this embodiment uses the screws 51 to lock the track 3 so that the sliding slot 22 is mounted on the latch hook member 21, such a mechanism may be constructed in an inter-exchanged structure, in a protuberance and concave structure, in a sliding slot and a sliding track fashion or in an equivalent structure.

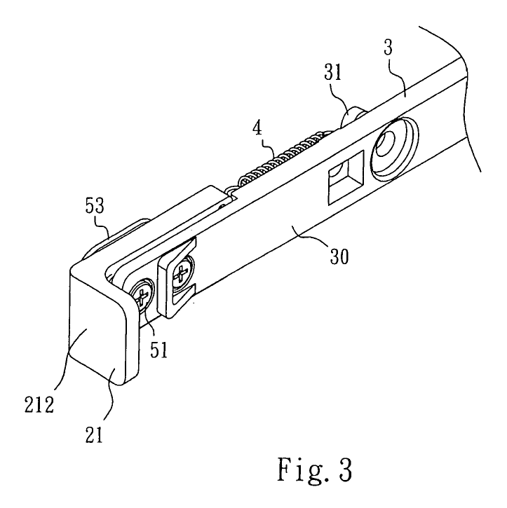

The straight plate 211 has a front edge integrally formed with a latch hook part 212. The sliding track 3 further comprises a structure 31 for fixing the spring and two threaded holes 32. Also, the latch hook member 21 is further connected to the structure 31 of the track 3 by means of a restoring spring 4. The spring 4 includes two hooks 41, 42 at the both ends thereof respectively for hooking up the structure 31 and the sliding slot 22. The restoring spring 4 provides a backward restoring elastic force with the latch hook member 21 to keep the latch hook part 212 aligned with the ornamental front face 11 of the removable storage device 1, the latch hook member 21 having a latch hook space H reserved around the peripheral edge thereof. FIG. 3 shows a form of the assembly.

With the structure as disclosed in FIG. 2, the latch hook member 21 is capable of sliding along the longitudinal axis of the sliding slot 22. Hence, the latch hook structure of the present invention is ordinarily aligned with the surface of the removable storage device nearly at the same level. Thus, the present invention not only is ornamental in appearance but also prevents the removable storage device form being detached as a result of the user's inadvertent touch. On the other hand, when the user likes to replace the removable storage device, his index finger slightly stretches into the latch hook space H next to the latch hook member 21 at the beginning as shown in FIG. 1. In this embodiment, the spring 4 is merely to have the latch hook member 21 restored to its initial position, the spring 4 will not generate an elastic force strong enough to prevent the latch hook member 21 from being removed. As such, user can easily takes the latch hook member 21 away from the removable storage device, and then, the removable storage device is thoroughly pulled out by both the user's index finger and thumb.

It is inferable from the above embodiment that the latch hook structure for the removable storage devices according to the present invention ordinarily has an ornamental and flat appearance. When the user intends to replace the removable storage device, the removable storage device can pull out easily by the latch hook structure.

Although the present invention has been explained in relation to its preferred embodiment, it is to be understood that many other possible modifications and variations can be made without departing from the spirit and scope of the invention as hereinafter claimed.

1. A latch hook structure of removable storage devices, comprising:
a removable storage device having an ornamental front face and two sides where two tracks parallel to each other are mounted respectively, wherein at least one of said two tracks has a fist sliding structure at the front end thereof, and
at least a latch hook member correspondingly assembled to said front end of said at least one track, wherein said hooking member includes a straight plate having a front edge integrally formed with a latch hook part around which a latch hook space is reserved and a second sliding structure corresponding to said fist sliding structure of said at least one track to effect a relative slide backwards and forwards, and is further connected to said at least one track with a restoring spring for providing said at least one latch hook member with a backward restoring elastic force to keep said latch hook part aligned said the ornamental front face of said removable storage device for a long term.

2. The latch hook structure of claim 1, wherein said first sliding structure of said at least one track is constituted by two screws disposed in parallel, and said second sliding structure of said at least one latch hook is constituted by a sliding slot.

3. The latch hook structure of claim 1 wherein said removable storage device is a removable CD player.

4. The latch hook structure of claim 1, wherein said removable storage device is a removable hard disk.
